(19) United States
(12) Patent Application Publication
(10) Pub. No.: US 2014/0019866 A1
(43) Pub. Date: Jan. 16, 2014

(54) HUMAN INTERFACE DEVICE INPUT HANDLING THROUGH USER-SPACE APPLICATION

(71) Applicant: Gregory Michael Stone, Arvada, CO (US)

(72) Inventor: Gregory Michael Stone, Arvada, CO (US)

(73) Assignee: ORACLE INTERNATIONAL CORPORATION, Redwood City, CA (US)

(21) Appl. No.: 13/550,566

(22) Filed: Jul. 16, 2012

(51) Int. Cl. G06F 3/01

(52) U.S. Cl. 715/733

(57) ABSTRACT

Embodiments include systems and methods for handling human interface device events using a user-space application. For example, a touch screen device and controller are in communication with a first processor on one side of a data link, and the first processor is in communication with a second processor on another side of the data link. The first processor receives touch screen events from the touch screen controller, along with associated coordinates, and packetizes the touch screen event data for communication over the data link to the second processor. The data is received at the second processor by a user-space application operable to parse the link traffic to receive the touch screen events and associated coordinates and to generate a corresponding graphics manager event from the touch screen event. The graphics manager event can be communicated to a graphics manager application that controls the display of the touch screen device.

### FIELD

Embodiments relate generally to physical user interfaces, and, more particularly, to handling human interface inputs through user-space processing.

### BACKGROUND

Storage library systems are often used by enterprises and the like to efficiently store and retrieve data from storage media. In the case of some storage libraries, the media are data cartridges (e.g., tape cartridges) that are typically stored and indexed within a set of magazines. When particular data is requested, a specialized robotic mechanism finds the appropriate cartridge, removes the cartridge from its magazine, and carries the cartridge to a drive that is designed to receive the cartridge and read its contents. Some storage libraries have multiple drives that can operate concurrently to perform input/output (IO) operations on multiple cartridges.

It is desirable in some implementations to allow for direct user interactivity via one or more human interface devices, including touch screen devices. The touch screen interactions are detected by a touch screen controller and passed to a processor for handling. In typical implementations, a processing environment is selected to have kernel-space device driver support for such touch screen controller output. This allows the processing environment to freely communicate with the touch screen controller. However, some processing environments do not have and/or do not practically support a kernel-space touch screen device driver, which can limit or prevent the processing environment from handling touch screen events.

### BRIEF SUMMARY

Among other things, embodiments provide novel systems and methods for handling human interface device events using a user-space application. In one embodiment, a touch screen device and controller are in communication with a first processor on one side of a universal serial bus (USB) link, and the first processor is in communication with a second processor on another side of the USB link. The first processor receives touch screen events from the touch screen controller, along with associated coordinates. The first processor then packetizes the touch screen event data for communication over the USB link in such a way that the data appears to be coming over the link as standard data from a standard device (e.g., CDC/ACM serial data coming from a USB ttyACM device). The data is received at the second processor by a user-space application operable to parse the link traffic to receive the touch screen events and associated coordinates. The user-space application generates a corresponding graphics manager event from the touch screen event and communicates the graphics manger event to a graphics manager application (e.g., also running on the second processor). For example, the graphics manager application is an X windows system (e.g., a version of the “X Window System,” like “X11,” or the like) and the graphics manager event is a run-time library call to an X server instance controlling a graphical user interface with which the user interacted via the touch screen device display.

According to one set of embodiments, a user interface system is provided. The user interface system includes: a human interface device operable to convert a user's physical interaction with the human interface device into associated coordinates; and a first processor operable to: receive human interface event data indicating the user's physical interaction with the human interface device and the associated coordinates; packetize the human interface event data according to a protocol readable by a user-space application running on a second processor so as to be converted by the user-space application into a graphics manager event for a graphics manager application; and communicate the packetized human interface event data over a data link to the second processor. Some such embodiments further include the second processor, which is operable to: receive the packetized human interface event data via the data link; and convert the packetized human interface event data by the user-space application into the graphics manager event for the graphics manager application. Some such embodiments further include a controller operable to: receive, from the human interface device, human interface data indicating the user's physical interaction with the human interface and the associated coordinates; generate a human interface event comprising the human interface event data and an event notification; and communicate the human interface event from the controller to the first processor.

According to another set of embodiments, a method for handling human interface inputs using a user-space application is provided. The method includes: receiving, by a first processor, human interface event data indicating a user interaction with a human interface device and associated coordinates; packetizing the human interface event data by the first processor according to a protocol readable by a user-space application running on a second processor so as to be converted by the user-space application into a graphics manager event for a graphics manager application; and communicating the packetized human interface event data over a data link from the first processor to the second processor. Some such embodiments further include: receiving, by a controller from a human interface device, human interface data indicating the user interaction with the human interface and associated coordinates; generating, by the controller, a human interface event comprising the human interface event data and an event notification; and communicating the human interface event from the controller to the first processor. Some such embodiments further include: receiving the packetized human interface event data at the second processor via the data link; and converting the packetized human interface event data by the user-space application into the graphics manager event for the graphics manager application.

According to yet another set of embodiments, a first processor is provided that is disposed in a user interface system having a human interface device, a second processor, and a data link. The first processor has a tangible, non-transient storage medium with instructions stored thereon, which, when executed, cause the first processor to perform steps including: receiving human interface event data indicating a user's physical interaction with the human interface device and associated coordinates; packetizing the human interface event data according to a protocol readable by a user-space application running on the second processor so as to be converted by the user-space application into a graphics manager event for a graphics manager application; and communicating the packetized human interface event data over the data link to the second processor.

### BRIEF DESCRIPTION OF THE DRAWINGS

The present disclosure is described in conjunction with the appended figures:

FIG. 1 shows a block diagram of an illustrative rack-mounted storage library, to provide a context for various embodiments;

FIGS. 2A and 2B show rear and front views, respectively, of an illustrative base module, according to various embodiments;

FIGS. 3A and 3B show rear and front views, respectively, of an illustrative expansion module, according to various embodiments;

FIG. 4 shows a projected partial view of an illustrative data storage system, according to various embodiments;

FIG. 5 shows a simplified functional block diagram of an illustrative base module 110, according to various embodiments; and

FIG. 6 shows a flow diagram of an illustrative method for handling touch screen inputs with a user-space application, according to various embodiments.

In the appended figures, similar components and/or features may have the same reference label. Further, various components of the same type may be distinguished by following the reference label by a second label that distinguishes among the similar components. If only the first reference label is used in the specification, the description is applicable to any one of the similar components having the same first reference label irrespective of the second reference label.

### DETAILED DESCRIPTION

In the following description, numerous specific details are set forth to provide a thorough understanding of the present invention. However, one having ordinary skill in the art should recognize that the invention may be practiced without these specific details. In some instances, circuits, structures, and techniques have not been shown in detail to avoid obscuring the present invention.

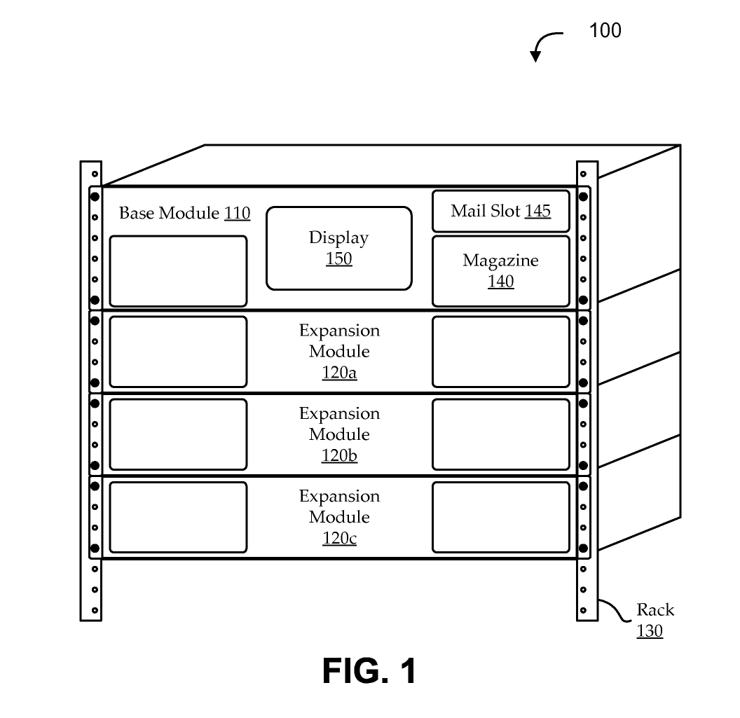

For the sake of context, FIG. 1 shows a rack-mounted storage library 100 for use with various embodiments. The storage library 100 includes a base module 110 and one or more expansion modules 120, configured to be mounted in an equipment rack 130 (only the mounting rails of the equipment rack 130 are shown for simplicity). The base module 110 and expansion modules 120 provide physical storage for multiple storage media cartridges (e.g., tape cartridges) in magazines 140. Embodiments also include one or more media drives (e.g., tape drives), controllers, power supplies, indicators, communications subsystems, and/or other functions. As will be discussed more fully below, the storage library 100 also includes a robotic mechanism for finding and ferrying storage media cartridges between locations within the storage library 100 (e.g., magazines 140 and drives).

According to an illustrative embodiment, the storage library 100 is a small, rack-mounted, automated tape library. The base module 110 is “3 RU” high (three standard rack units, or approximately 5.25-inch high) and includes one robotic mechanism. Up to nine additional, “2 RU” high (approximately 3.5-inch high) expansion modules 120 can be added to provide additional drive and/or magazine 140 slot capacity, so that a maximum configuration of one base module 110 and nine expansion modules 120 has a total height of “21 RU,” or half of a standard equipment rack 130. The single robot mechanism is configured to access all magazine 140 slots and drives in the base module 110 and all expansion modules 120.

In the illustrative embodiment, each of the base module 110 and the expansion modules 120 can house up to two half-height or one full-height LTO5 tape drives. Each of the base module 110 and the expansion modules 120 can also house two removable magazines 140, each having fifteen cartridge slots. In some implementations, the storage library 100 can be divided into partitions each associated with, for example, at least one drive and at least one magazine 140. Each partition can be configured to behave as an independent library, notwithstanding that all partitions share the single robotic mechanism (e.g., partitions can be commanded as independent libraries for tape operations, while sharing many resources for service and administration). Some implementations also include a “mailslot” 145 in the base module 110, as discussed below.

Some embodiments provide local and remote management of various functions through graphical user interfaces (GUI). In one implementation, the local interface GUI is displayed on a seven-inch, front-mounted, touch-screen panel display 150. The remote interface may be implemented as a browser-based interface (BUI), accessible by connecting a web browser to the library's Internet protocol (IP) address.

Some embodiments are configured to be installable and serviceable by end customers to the greatest extent practical. For example, an installation wizard may be provided to simplify initial installation, a simple rack rail system for base modules 110 and expansion modules 120 will allow two people without any mechanical assistance (e.g. lift) to easily install the modules on an equipment rack 130. In some such embodiments, most replaceable library components will be Customer Replaceable Units (CRUs) (i.e., as opposed to field replaceable units (FRUs), which are serviceable and/or replaceable only by trained technicians). For example, certain implementations allow almost all installation, maintenance, upgrades, and/or normal use of the storage library 100 to be performed with only front and rear access to the equipment rack 130 and few or no tools.

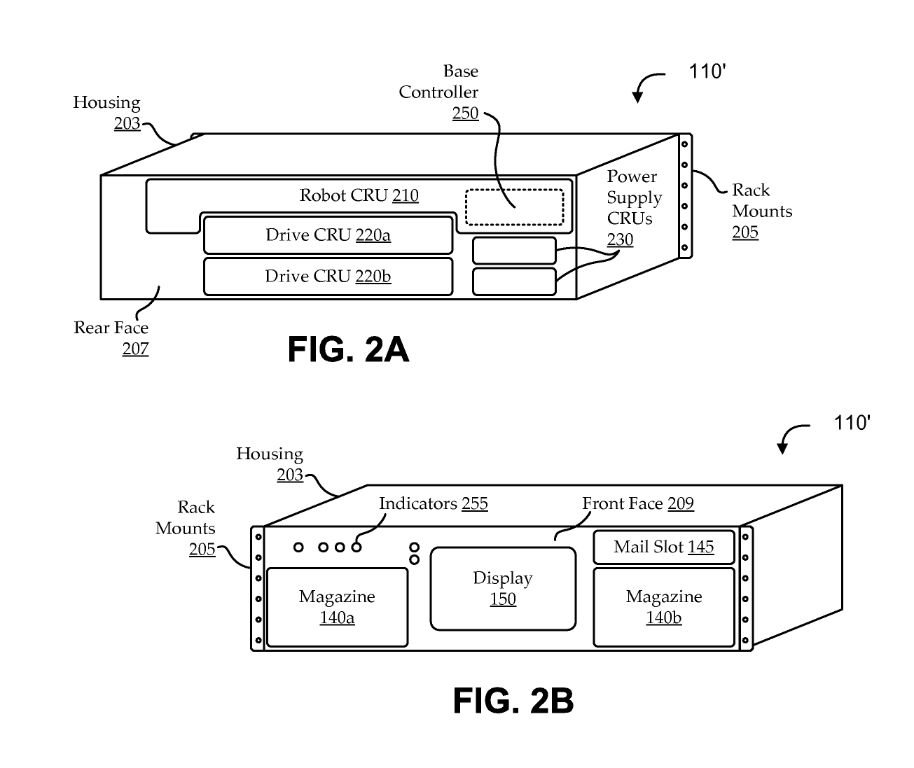

FIGS. 2A and 2B show rear and front views, respectively, of an illustrative base module 110, according to various embodiments. The illustrative base module 110 may be an implementation of base module 110 of FIG. 1. As shown, the base module 110 includes a housing 203 (e.g., a chassis) configured with rack mounts 205 for mounting to an equipment rack (e.g., as shown in FIG. 1). A rear face 207 and a front face 209 are also shown as part of the housing 203. As discussed above, embodiments such as the one illustrated as base module 110, are designed to facilitate customer serviceability. Accordingly, most of the replaceable components are shown as accessible from the front and rear exterior of the base module 110, which would be substantially exposed when mounted in a standard equipment rack.

Looking at the rear view of the base module 110 in FIG. 2A, access is provided to a robot CRU 210, one or more drive CRUs 220, and one or more power supply CRUs 230. As will be described more fully below, the robot CRU 210 is configured to house the robotic mechanism and supporting components (e.g., mechanical drive modules, control hardware and software modules, configuration memory, etc.). Traditional storage library systems typically are configured so that the robotic mechanisms are only serviceable by highly trained personnel, and even removing the mechanism to send out for off-site servicing requires training, specialized tools, or the like. The ability to replace the entire robotic mechanism and all its supporting components in a single CRU is a novel improvement over traditional implementations. For example, implementations allow a customer to simply pop out a broken robot CRU 210 using a couple of thumb screws, slide in a replacement CRU, and reinitialize the system, without waiting for a technician to troubleshoot and fix any issues.

Embodiments of the drive CRUs 220 are media drive modules that can be removed by an end consumer. Various implementations support standard, half-height or full-height tape drives. As described more fully below, the port in the drive for receiving a media cartridge faces into the base module 110, so that media cartridges can only be inserted and/or removed by the robotic mechanism within the confines of the housing 203. In some implementations, one or more “external” media drives may be provided to facilitate troubleshooting and the like.

Embodiments of the power supply CRUs 230 include any useful type of power supply components for supplying power to the base module 110 and or to any other components (e.g., to one or more expansion modules 120 (not shown)). For example, the power supply CRUs 230 can include power generators, power converters, power conditioners, back-up batteries and/or other power duplication, switches, input and/or output ports, indicators, and the like. In some implementations, each power supply CRU 230 includes a male, three-prong connector for interfacing with line power and a main power switch. Some embodiments include a power supply CRU 230 for each drive CRU 220 (i.e., if the base module 110 has only a single drive CRU 220, it may also only have a single power supply CRU 230 to support the drive). In other embodiments, a second power supply CRU 230 is used as a backup supply to the first power supply CRU 230, and may be coupled with a different power source.

In one implementation, the base module 110 has slots for two power supplies (e.g., two power supply CRUs 230). These can be implemented as custom power supplies, for example, having an input voltage of 100-250 volts AC at 50-60 Hertz, and an output voltage of twelve volts DC switched plus five volts DC standby power. For example, the power supplies may be sized to run two tape drives plus robotics and any other sensors, etc. (e.g., with or without redundancy). Typically, the base module 110 has at least one power supply, even if no drives are included, to support the main processor, interface functionality (e.g., the display 150), etc.

Embodiments of the base module 110 include a base controller 250 (or base processing subsystem). In some implementations, the base controller 250 is part of the robot CRU 210. In other implementations, the base controller 250 is implemented as its own module or as part of another CRU of the base module 110. Embodiments of the base controller 250 include a main processor (e.g., a central processing unit (CPU), or any suitable processor) and one or more peripheral interface controller (PIC) microcontrollers or the like. In one embodiment, the base controller 250 includes four PIC microcontrollers: two PIC microcontrollers for operating motors and for monitoring motion sensors; a third PIC microcontroller for interfacing with drive CRUs 220, power supply CRUs 230, and various position sensors; and a fourth PIC microcontroller for interfacing between touch screen events and graphics display (e.g., via display 150) on the operator panel back and the main processor. As used herein, “base controller” and “base processing subsystem” are used interchangeably to include the one or more processors, PICs, etc. that make up the base controller 250.

Looking at the front view of the base module 110 in FIG. 2B, access is provided to a display 150, one or more magazines 140, and a mailslot 145. One or more indicators 255 may also be provided to show certain operational states, and the like (note that the sizes, numbers, positions, etc. of the indicators shown are intended only to be illustrative). In various implementations, base module 110 has overall library status indicators on the front and back of the module, along with a locate switch which activates the front and back locate LEDs; powered CRUs may have their own status indicators; hot-swappable CRUs can have indicators that show when the CRUs can be safely removed; power supplies and tape drives can have additional indicators; an “AC present” indicator can be provided to stay on even when the storage library is off (as long as AC power is connected). In one embodiment, a set of primary indicators include “locate,” “fault,” and “OK” indications. Next to the primary indicators are secondary indicators specific for the operator panel that indicate the status of the operator panel (e.g., an operator panel CRU, if implemented as such).

Other types of indications, status, and interaction can also be provided via the display 150. Embodiments of the display 150 are used to facilitate various functionality through a local graphical user interface (GUI), including, for example, IO functions, service and diagnostic functions, etc. In one implementation, the display 150 is a seven-inch, front-mounted, touch-screen panel (e.g., an LCD touch panel display with a WVGA (wide VGA) 800×480 pixel screen.

In some embodiments, the display 150 is equipped with a resistive or capacitive touch-sensitive overlay. Implementations use the touch-sensitive overlay (“touch screen”) for local control of the library, and can provide capabilities similar to that of a one-button mouse, a multi-touch display, or any other human interface device. For example, the user can tap the screen to select a virtual button, move a finger across the screen to move a virtual pointer or cursor, etc. Some embodiments use the touch screen interface of the display 150 to control a graphical user interface (GUI), which in some implementations includes a browser user interface (BUI).

Each magazine 140 can be configured to hold multiple (e.g., up to fifteen) cartridges in such a way as to be reliably accessed by the robotic mechanism. For example, the magazines 140 can be designed to have features to aid in targeting, location, and or other functions of the robotic mechanism; features that securely hold the cartridges in place, while allowing for easy release of the cartridges to a robotic gripper when desired; features to add strength to the magazines 140 (e.g., to reduce sag, increase usable life, etc.) and/or to reduce weight; etc.

Embodiments of the mailslot 145 (or “Cartridge Access Port” (CAP)) include a special type of magazine designed to act as a controlled interface between the human user and the robotic mechanism. To add or remove cartridges from the storage library, a user ejects the mailslot 145 from the base module 110 and is presented with a number of cartridge slots (e.g., four “Import/Export cells” (“I/E cells”)). The user can then insert cartridges into, or remove cartridges from, these slots without interfering with robotic mechanism's operations. In some implementations, the robotic mechanism is used to activate a latch internal to the base module 110, thereby allowing the user to remove the mailslot 145 only when the robotic mechanism is in an appropriate condition (e.g., parked in the robot CRU 210). Certain embodiments having data partitions (as discussed above) only allow one partition at a time to make use of the mailslot 145.

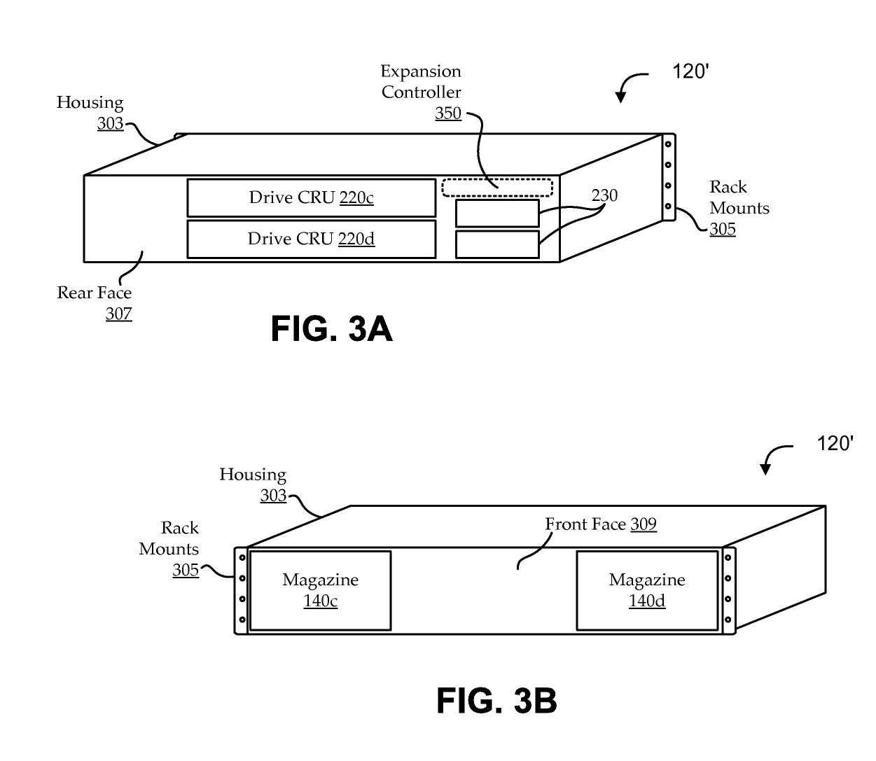

FIGS. 3A and 3B show rear and front views, respectively, of an illustrative expansion module 120, according to various embodiments. The illustrative expansion module 120 may be an implementation of expansion module 120 of FIG. 1. As shown, the expansion module 120 includes a housing 303 (e.g., a chassis) configured with rack mounts 305 for mounting to an equipment rack (e.g., as shown in FIG. 1). A rear face 307 and a front face 309 are also shown as part of the housing 303. As with the base module 110 of FIGS. 2A and 2B, the expansion module 120 is designed to facilitate customer serviceability. Most of the replaceable components are shown as accessible from the front and rear exterior of the expansion module 120, which would be substantially exposed when mounted in a standard equipment rack.

In the embodiment shown, various aspects of the expansion module 120 are similar or identical to the base module 110. For example, embodiments of the expansion module 120 do not typically have a robot CRU 210, display 150, or mailslot 145, as they are configured to exploit that functionality from the base module 110 components. However, like the base module 110, the expansion module 120 includes one or more drive CRUs 220 and one or more power supply CRUs 230 configured to be accessed from the rear side of the expansion module 120, and one or more magazines 140 configured to be accessed from the front side of the expansion module 120. In some embodiments, the drive CRUs 220, power supply CRUs 230, and/or magazines 140 of the expansion module 120 are the same as those implemented in the base module 110.

Because of the lack of certain features in embodiments of the expansion module 120 (e.g., there may be no robot CRU 210, no main processor, etc.), expansion module 120 power requirements may be different from those of the base module 110. In certain implementations, the expansion modules 120 still have slots for two power supplies (e.g., two power supply CRUs 230), which can be implemented as the same power supplies used in the base module 110 (e.g., to avoid having to support or source multiple types of power supplies). The expansion power supplies (i.e., the power supply CRUs 230) can be standard or custom power supplies. In one embodiment, each power supply is designed with an input voltage of 100-250 VAC at 50-60 Hz, and an output voltage of 12 VDC switched plus 5 VDC standby power. These voltages may be chosen to run up to two tape drives in the expansion module 120 and/or other operational components. However, the power supplies of the base module 110 may provide more power than is needed to run configurations of the expansion modules 120. For example, a single power supply may be able to support an expansion module 120 even with two drives, and it is possible to implement an expansion module 120 with no drives and no power supplies. Alternatively, two power supplies may still be used, for example, to provide redundancy.

Some embodiments of the expansion modules 120 include an expansion controller 350. The expansion controller 350 may be similar to the base controller in some implementations, though other implementations may use an expansion controller 350 with appreciably less functionality than that of the base controller 250. The expansion controller 350 may include one or more PIC microcontroller. In one embodiment, the expansion controller 350 includes a PIC microcontroller for interfacing with the module's drive CRUs 220, power supply CRUs 230, various sensors, and/or other components. As described above, some embodiments of expansion modules 120 have no power supplies and/or drives (e.g., they have only magazines 140 for additional cartridge storage), though some such expansion modules 120 still have expansion controllers 350 for performing various functions (e.g., for detecting and communicating power failures, sensor functions, etc.).

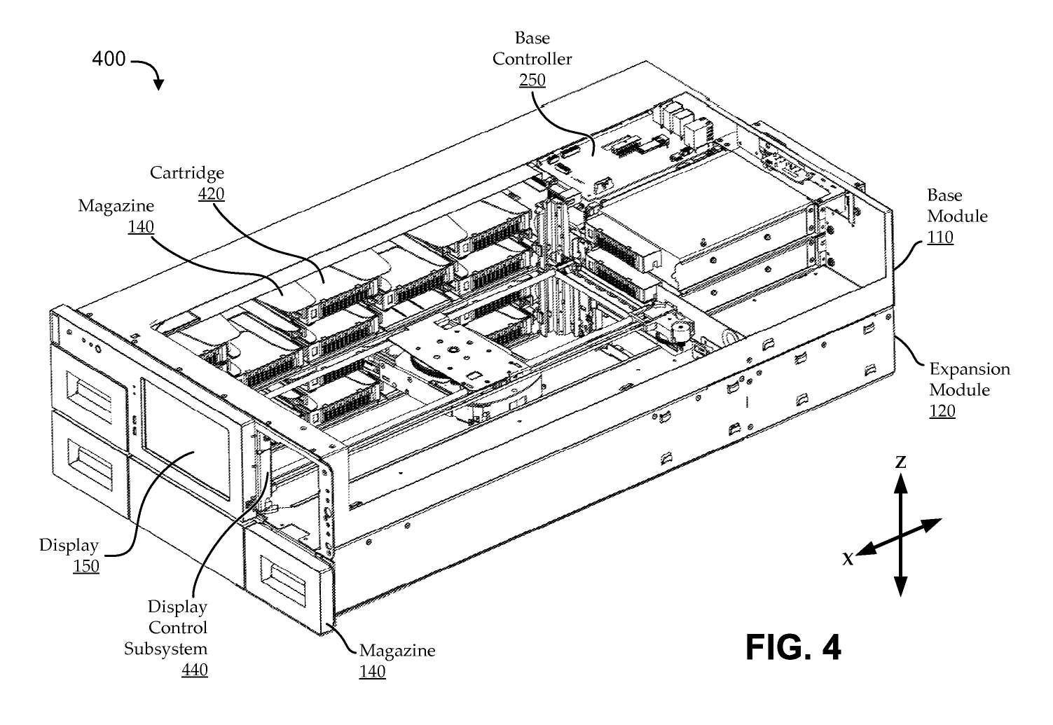

FIG. 4 shows a projected partial view of an illustrative data storage system 400, according to various embodiments. The data storage system 400 includes a base module 110 and multiple expansion modules 120. As described above, the modules can be configured to hold magazines 140 with data cartridges 420, to support robotic mechanism operations, to hold one or more tape drives and/or other operational components, etc. In some embodiments, the base module 110 includes a base controller 250 that can act as the main processor of the data storage system 400. Each expansion module 120 can also have its own expansion controller (not shown).

In some implementations, the base module 110 includes a display 150. Functionality of the display 150 can be handled at least in part by a display control subsystem 440. The display control subsystem 440 can include a touch screen controller, one or more microprocessors (e.g., PICs), and/or any suitable components. In some implementations, functionality of the display 150 is further handled by the base controller 250 and/or by communications between the base controller 250 and the display control subsystem 440.

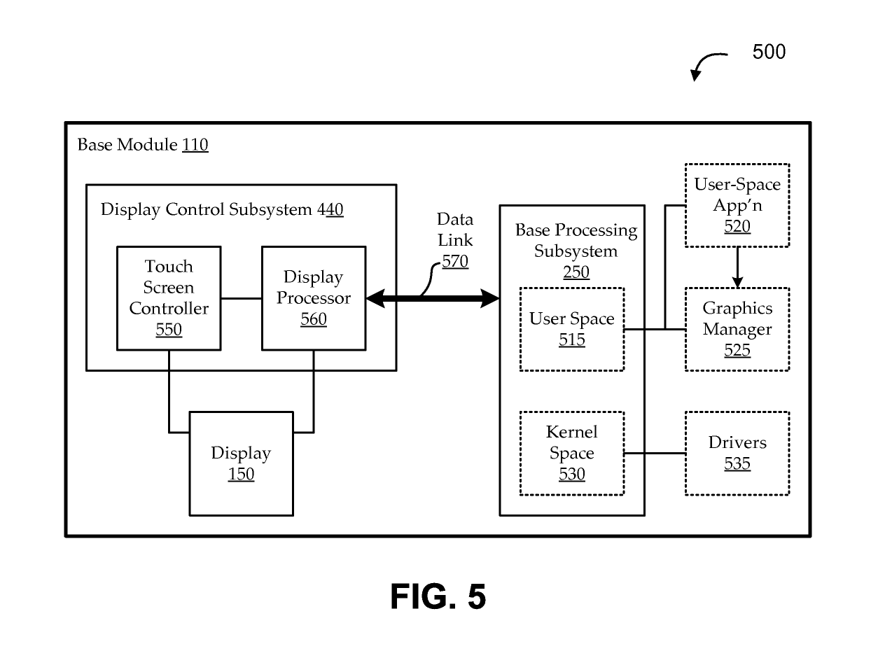

FIG. 5 shows a simplified functional block diagram 500 of an illustrative base module 110, according to various embodiments. Embodiments of the base module 110 include a display 150, a display control subsystem 440, and a base processing subsystem 250. The display control subsystem 440 includes a touch screen controller 550 and a display processor 560 that is in communication with the base processing subsystem 250 over a data link 570. For example, as described above, the base processing subsystem 250 may include a PIC microcontroller that handles interfacing between touch screen events and graphics display on the display 150 and a main central processor of the base processing subsystem 250.

In some embodiments, the display 150 is a touch screen device operable to convert a user's physical interaction with the touch screen device into associated coordinates. For example, when a user touches the screen with a finger, capacitive, resistive, and/or other techniques are used to determine a location associated with the touch in a coordinate system of the touch screen device. In one implementation, a resistive touch screen device is operable to determine a location of a touch event in an effective range of 100-4000 in an X-dimension and 100-4000 in a Y-dimension. The touch event can be detected and the associated coordinates (e., raw X-Y data) can be determined by the touch screen controller 550.

In some traditional implementations, the raw X-Y data is communicated to a main processor having a kernel-space device driver for the touch screen device. The device driver acts as a translator at the kernel level between specific characteristics of the device and specific characteristics of the operating system of the processor. It is assumed for the sake of embodiments herein that there is no device driver for the touch screen display 150 and/or no support for such a device driver. Accordingly, embodiments handle the touch screen inputs in the user space (not the kernel space) using additional processing capabilities and a user-space application, as described below.

If the raw X-Y data were sent directly to the base processor 250 without an associated device driver, the base processor 250 may not have any way to interpret or decode the raw X-Y data, to relate the data to a physical interface event, etc. Embodiments of the touch screen controller 550 send the raw X-Y data to the display processor 560, and the display processor 560 formats the data for delivery to a user-space application 520 of the base processor 250. The display processor 560 can be implemented as a PIC microcontroller or using any other suitable device or devices. In some implementations, the raw X-Y data may be sent along with an event notification (e.g., an interrupt, message, etc.) to facilitate awareness by the display processor 560 that a touch screen event has occurred. Accordingly, the display processor effectively receives touch screen event data indicating a user's physical interaction with the touch screen device (via the display 150) and associated coordinates.

In some embodiments, the display processor 560 packetizes the touch screen event data into a defined data packet for communication. The packet may be formatted according to a protocol readable by the user-space application 520 running on the base processor 250. In some implementations, the display processor 560 is coupled via the data link 570 with the base processor 250, and the data is packetized so that the display processor 560 looks to the base processor 250 over the data link 570 like a standard type of device. In one embodiment, the data link 570 is a universal serial bus (USB) link, and the port of the display processor 560 in communication with the USB link communicates according to a USB Communications Device Class Abstract Control Model (CDC/ACM) device. For example, the base processor 250 sees the display processor 560 port as a standard serial port (e.g., RS232), and the data can be communicated to look like standard serial data coming from a standard USB device (e.g., “/dev/ttyACM*” in a Linux environment, where “*” is the ID associated with the device). However, the data is formatted (e.g., packetized) to be decoded as touch screen event data by the user-space application 520 of the base processor 250.

Embodiments of the base processor 250 are operable to receive the packetized touch screen event data via the data link 570 and to convert the packetized touch screen event data into a useful graphics manager event. As illustrated, the base processor has a user space 515 and a kernel space 530. Typically, virtual memory is segregated (e.g., by processor operating systems) into kernel space 530 and user space 515. Kernel space 530 is reserved for running the kernel, kernel extensions, and device drivers. User mode applications run in user space 530. In the embodiment shown, the user space 515 includes the user-space application 520 and a graphics manager application 525, and the kernel space 530 includes one or more kernel-space device drivers 535.

In a traditional implementation (e.g., assuming a USB data link 570), the USB host enumerates the touch screen device to identify a device type, interfaces, etc. This allows the host to recognize the device as a USB touch screen device and associate the device with corresponding requirements (e.g., power requirements). The operating system can then attach a kernel-space device driver to the device, so the operating system can communicate directly with the device via the device driver. Embodiments operate in contexts where there is no kernel-space device driver, so the operating system is unable to recognize it as such or to directly communicate with it.

As discussed above, the base processor 250 receives the data as a packet of standard communications data (e.g., serial port data), and only recognizes the data as touch screen event data when decoded by the user-space application 520. The user-space application 520 may be implemented as any suitable type of user mode application, including, for example, a daemon or other background-type of application. The user-space application 520 is operable to recognize the data packets from the display processor as corresponding to touch screen events with associated coordinates in context of a touch screen coordinate space (e.g., 100-4000 in each of an X and Y dimension). The user-space application 520 is further operable to convert the touch screen event into a graphics manager event for the graphics manager application 525. The graphics manager application 525 can be any type of graphics manager, display manager, window manager, etc.

In one implementation, the graphics manager application 525 is an X windows system that controls graphical information being displayed on the display 150 via an X server. In other implementations, other types of display and/or window managers are used with or without remote server functionality. In some embodiments, the graphics manager application 525 operates in a different coordinate system from that of the touch screen device. For example, the touch screen functionality of the display may detect values ranging from 100-to-4000 in each of two dimensions, while the graphical display functionality of the display 150 may have a resolution of 400-by-800 pixels. Accordingly, raw X-Y coordinates associated with a touch screen event may be converted to corresponding display values to determine how the physical interaction corresponds with a virtual display interaction. For example, a set of virtual buttons is shown on the display 150 via a GUI, each having corresponding display coordinates. When a user's finger contacts the touch screen, the detected raw coordinates may be converted into display coordinates to determine which of the set of virtual buttons was selected by the user. This button selection may be one type of graphics manager event. Other graphics manager event can include any useful type of interaction, including, for example, single-click, double-click, slide, drag and drop, pan, zoom, rotate, etc. In some cases, the graphics manager application 525 is further operable to modify the display according to the event. For example, the display may change in response to detecting the button selection (e.g., the button may highlight, a new interface may be displayed, etc.).

Various techniques are possible for using the user-space application 520 to convert the touch screen event data into a graphics manager event for the graphics manager application 525. In some implementations, the packetized touch screen event data is converted to a test event usable by the graphics manager application without a corresponding enumerated device. For example, an “xfake” command or the like in an X windows or similar system can be used to send test events to the graphics manager application 525 for testing purposes (e.g., a “fake” mouse click or other event can be sent to the graphics manager application 525 to test application functionality without having an actual mouse connected to the system). This functionality can be exploited to send a fake event that looks like a touch screen event (e.g., or a mouse event or other human interface device event), and the graphics manager application 525 can respond accordingly. In other implementations, the packetized touch screen event data is converted to an event that can be handled by an existing kernel-space or other device driver for a different human interface device. For example, if the operating system of the base processor 250 has support for a mouse driver but no touch screen driver, the user-space application 520 can convert the touch screen event data into data that appears to the operating system as a mouse event for handling via its mouse driver, and the graphics manager application 525 can respond accordingly.

For the sake of clarity, various embodiments are described herein with specific reference to touch screens, touch screen devices, touch screen controllers, and the like. Similar or identical techniques can be applied in context of other types of human interface devices (e.g., computer mouse interfaces, keypad or keyboard interfaces, biometric interfaces, etc.) without departing from the scope of embodiments. Further, embodiments are described as including controllers, processors, data links, and other components. While some embodiments implement some or all of those components as separate, other embodiments implement some or all of those components as a single module or as multiple functions of a single component. For example, the touch screen controller 550, display processor 560, and base processing subsystem 250 are all functional modules of a single device, and the data link 570 is implemented as an internal messaging link (e.g., or socket or the like). Accordingly, references to specific types of interface devices, component configurations, etc. are intended to be illustrative and should not be construed as limiting the scope of embodiments.

The various system embodiments described above are intended only to illustrate certain inventive functionality and contexts therefor. The system can be varying in many ways without departing from the scope of embodiments, including adding, removing, and/or replacing components. Accordingly, the systems described above can be used for performing functions other than those described herein, and the inventive functions described herein can be performed on systems other than those described above.

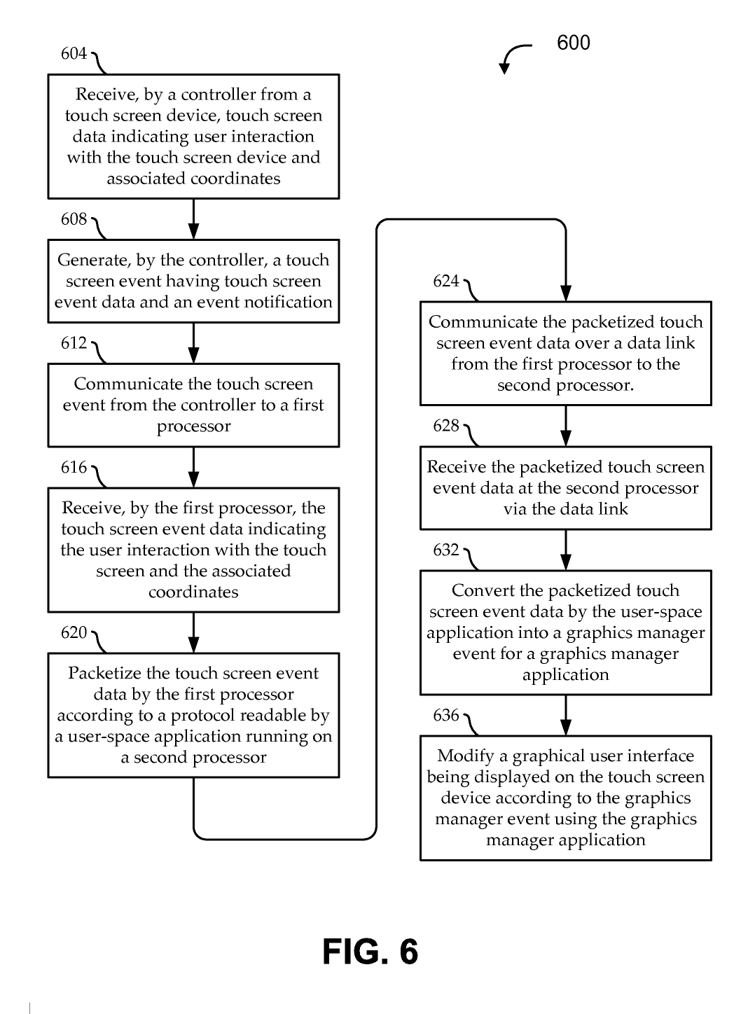

Turning to FIG. 6, a flow diagram is shown of an illustrative method 600 for handling touch screen inputs with a user-space application, according to various embodiments. Embodiments of the method 600 begin at stage 604 by receiving touch screen data indicating user interaction with the touch screen device and associated coordinates. The touch screen data may be received by a controller from a touch screen device. For example, a display shows a graphical user interface having a number of virtual buttons representing options for selection by a user. The user can touch one of the virtual buttons on the display (e.g., touch the display screen in a region falling within the graphical boundaries of the virtual button), thereby interacting with the virtual button and with the touch screen device. Coordinates at which the user touched the screen are detected and recorded by (or sent to) the touch screen controller.

At stage 608, a touch screen event is generated (e.g., by the controller) having touch screen event data and an event notification. For example, when the user touches the touch screen device, the associated coordinates are detected and recorded by the controller, and the controller is operable to generate a notification message with those coordinates for use by another component. The notification message can be configured and handled as an interrupt, a switch, a data communication, or in any suitable way. The touch screen event can be communicated from the controller to a first processor at stage 612. For example, the controller may be a dedicated component, packaged with or otherwise in direct communication with the touch screen device, and tailored to detecting the coordinates of a user interaction event and generating the associated touch screen event.

At stage 616, the first processor receives the touch screen event data indicating the user interaction with the touch screen and the associated coordinates. In some embodiments, the method 600 begins at stage 616 and focuses on stages performed by the first processor. The first processor may be a microprocessor or microcontroller (e.g., a PIC or the like), electrically coupled with or otherwise in communication with the touch screen controller, and configured to receive the touch screen event. In some implementations, the first processor and the touch screen controller are implemented in a single module and/or on a single circuit board. In other implementations, the first processor and the touch screen controller are implemented separately and are in communication over a data link, communications network, or the like.

Having received the touch screen event with the associated coordinates, the first processor is operable to convert the touch screen event into a format for communication to and handling by a second processor (e.g., a main central processor) without a touch screen device driver on that second processor. In some embodiments, at stage 620, the first processor packetizes the touch screen event data according to a protocol readable by a user-space application running on the second processor (e.g., the main processor). The protocol may be a packet format, including, for example, header information (e.g., a preamble, post-amble, mid-amble), error correction codes, and/or any other useful information.

At stage 624, the packetized touch screen event data is communicated over a data link from the first processor to the second processor. For example, the first processor is in communication over a USB link with the second processor. The first processor is recognized as a standard USB “ttyACM” device and is configured to communicate over the USB link as a CDC/ACM connection, so that the data communicated over the link looks to be originating from a serial port of a standard USB device. Other implementations use different types of data links, different port configurations, different communications formats, etc.

At stage 628, the packetized touch screen event data is received at the second processor via the data link. For example, the second processor receives the touch screen event data using a user-space application operable to monitor the ttyACM data traversing the data link and to understand the packet format. At stage 632, the user-space application converts the packetized touch screen event data into a graphics manager event for a graphics manager application. For example, the user-space application parses the packets to receive touch screen event data, including the associated coordinates. In some implementations, the touch screen event data may include additional information, such as multi-touch data, a touch screen event type (e.g., a slide may have a coordinate range and motion path and an association with a slide event type). The user-space application then generates whatever data in whatever form is useful to the graphics manager application as a graphics manager event. For example, the touch screen coordinates may be converted to display (e.g., GUI) coordinates), an event type may be generated (e.g., “button press,” “slide,” etc.), device emulation data may be generated (e.g., to make the event look like a mouse or other human interface device event), etc.

The graphics manager event is sent to the graphics manager application, for example, as a run-time library call. In some implementations, the graphics manager application is an X windows system. For example, the X windows system controls the GUI of the display as a window of an X server instance, and the graphics manager event is generated as an X server command. As discussed above, the X windows call may be issued in the form of an “xfake” type of call, which can cause the X windows to respond to the interaction event as in a test environment without any need to have an associated recognized (e.g., enumerated) device. Alternatively, the X windows call may be formatted to appear as though it originated from a device that is recognized (e.g., for which there is kernel-space device driver support), like a mouse or other human interface device.

Some embodiments of the method 600 continue at stage 636 by modifying a graphical user interface (GUI) being displayed on the touch screen device according to the graphics manager event using the graphics manager application. In the case of an X windows system, for example, the X windows system interprets the X windows call to determine how to modify the GUI in response to the user's interaction. For example, a virtual button press may cause the button to highlight, a new GUI menu to appear, electrical and/or mechanical functions to begin or end, etc.

It is worth noting that handling the touch screen events though a user-space application can provide certain features according to some embodiments. According to one such feature, in some implementations, the second processor is in communication with one or more other processors, systems, communications networks, etc., and some or all of those may issue calls to emulate touch screen events. For example, a remote terminal can issue a call to the user-space application (and/or via the user-space application and/or directly to the graphics manager application) to appear as though a user interaction event has occurred. In certain such implementations, the graphics manager application can respond to those calls in an identical fashion as though an actual user interaction event occurred, for example, causing the GUI to respond and/or other functions to occur accordingly. According to another such feature, implementations of the user-space application handling allow use of all stock components (e.g., freely available to operate with Linux or other operating systems, from microcontroller vendors, etc.) without the need for custom components. For example, relatively small pieces of glue logic allow the user-space application data to communicate with an X windows or other graphics manager application environment. Yet another such feature is that keeping the application in user space (e.g., as a daemon or other background application) allows for potentially greater portability.

The methods disclosed herein comprise one or more actions for achieving the described method. The method and/or actions may be interchanged with one another without departing from the scope of the claims. In other words, unless a specific order of actions is specified, the order and/or use of specific actions may be modified without departing from the scope of the claims.

The various operations of methods and functions of certain system components described above may be performed by any suitable means capable of performing the corresponding functions. The means may include various hardware and/or software component(s) and/or module(s), including, but not limited to a circuit, an application specific integrated circuit (ASIC), or processor. For example, logical blocks, modules, and circuits described may be implemented or performed with a general purpose processor, a digital signal processor (DSP), an ASIC, a field programmable gate array signal (FPGA), or other programmable logic device (PLD), discrete gate, or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm or other functionality described in connection with the present disclosure, may be embodied directly in hardware, in a software module executed by a processor, or in a combination of the two. A software module may reside in any form of tangible storage medium. Some examples of storage media that may be used include random access memory (RAM), read only memory (ROM), flash memory, EPROM memory, EEPROM memory, registers, a hard disk, a removable disk, a CD-ROM and so forth. A storage medium may be coupled to a processor such that the processor can read information from, and write information to, the storage medium. In the alternative, the storage medium may be integral to the processor. A software module may be a single instruction, or many instructions, and may be distributed over several different code segments, among different programs, and across multiple storage media. Thus, a computer program product may perform operations presented herein. For example, such a computer program product may be a computer readable tangible medium having instructions tangibly stored (and/or encoded) thereon, the instructions being executable by one or more processors to perform the operations described herein. The computer program product may include packaging material. Software or instructions may also be transmitted over a transmission medium. For example, software may be transmitted from a website, server, or other remote source using a transmission medium such as a coaxial cable, fiber optic cable, twisted pair, digital subscriber line (DSL), or wireless technology such as infrared, radio, or microwave.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

Various changes, substitutions, and alterations to the techniques described herein can be made without departing from the technology of the teachings as defined by the appended claims. Moreover, the scope of the disclosure and claims is not limited to the particular aspects of the process, machine, manufacture, composition of matter, means, methods, and actions described above. Processes, machines, manufacture, compositions of matter, means, methods, or actions, presently existing or later to be developed, that perform substantially the same function or achieve substantially the same result as the corresponding aspects described herein may be utilized. Accordingly, the appended claims include within their scope such processes, machines, manufacture, compositions of matter, means, methods, or actions.

What is claimed is:

1. A user interface system comprising:
a human interface device operable to convert a user's physical interaction with the human interface device into associated coordinates;
a first processor operable to:
receive human interface event data indicating the user's physical interaction with the human interface device and the associated coordinates;
packetize the human interface event data according to a protocol readable by a user-space application running on a second processor so as to be converted by the user-space application into a graphics manager event for a graphics manager application; and
communicate the packetized human interface event data over a data link to the second processor.

2. The user interface system of claim 1, further comprising:
the second processor operable to:
receive the packetized human interface event data via the data link; and
convert the packetized human interface event data by the user-space application into the graphics manager event for the graphics manager application.

3. The user interface system of claim 2, wherein the second processor is further operable to:
modify a graphical user interface being displayed via the human interface device using the graphics manager application according to the graphics manager event.

4. The user interface system of claim 1, further comprising:
a controller operable to:
receive, from the human interface device, human interface data indicating the user's physical interaction with the human interface and the associated coordinates;
generate a human interface event comprising the human interface event data and an event notification; and
communicate the human interface event from the controller to the first processor.

5. The user interface system of claim 1, wherein:
the associated coordinates are referenced to a human interface coordinate system defined by the human interface device; and
the user-space application is operable to convert the packetized human interface event data into the graphics manager event for the graphics manager application by converting the associated coordinates of the human interface coordinate system into corresponding coordinates of a display window coordinate system different from the human interface coordinate system.

6. The user interface system of claim 1, wherein the user-space application is operable to convert the packetized human interface event data into the graphics manager event for the graphics manager application by converting the packetized human interface event data by the user-space application to a test event usable by the graphics manager application without a corresponding enumerated device.

7. The user interface system of claim 1, wherein the user-space application is operable to convert the packetized human interface event data into the graphics manager event for the graphics manager application by converting the packetized human interface event data by the user-space application to appear to the graphics manager application as a different human interface device.

8. The user interface system of claim 1, wherein the graphics manager application is an X windows system.

9. The user interface system of claim 8, wherein the human interface is implemented on a display for interaction with a graphical user interface controlled via an X server of the X windows system.

10. The user interface system of claim 1, wherein the data link is a universal serial bus (USB) link.

11. The user interface system of claim 1, wherein the first processor is operable to communicate the packetized human interface event data over the data link to the second processor in such a way that the packetized human interface event data appears to the second processor as originating from a serial port.

12. The user interface system of claim 1, wherein the user-space application is a daemon running in an operating system of the second processor.

13. A method for handling human interface inputs using a user-space application, the method comprising:
receiving, by a first processor, human interface event data indicating a user interaction with a human interface device and associated coordinates;
packetizing the human interface event data by the first processor according to a protocol readable by a user-space application running on a second processor so as to be converted by the user-space application into a graphics manager event for a graphics manager application; and
communicating the packetized human interface event data over a data link from the first processor to the second processor.

14. The method of claim 13, further comprising:
receiving, by a controller from a human interface device, human interface data indicating the user interaction with the human interface and associated coordinates;
generating, by the controller, a human interface event comprising the human interface event data and an event notification; and
communicating the human interface event from the controller to the first processor.

15. The method of claim 13, further comprising:
receiving the packetized human interface event data at the second processor via the data link; and
converting the packetized human interface event data by the user-space application into the graphics manager event for the graphics manager application.

16. The method of claim 13, wherein:
the associated coordinates are referenced to a human interface coordinate system; and
converting the packetized human interface event data by the user-space application into the graphics manager event for the graphics manager application comprises converting the associated coordinates of the human interface coordinate system into corresponding coordinates of a display window coordinate system different from the human interface coordinate system.

17. The method of claim 16, further comprising:
modifying a graphical user interface being displayed via the human interface device using the graphics manager application according to the graphics manager event and the corresponding coordinates of the display window coordinate system.

18. The method of claim 13, wherein converting the packetized human interface event data by the user-space application into the graphics manager event for the graphics manager application comprises converting the packetized human interface event data by the user-space application to a test event usable by the graphics manager application without a corresponding enumerated device.

19. The method of claim 13, wherein converting the packetized human interface event data by the user-space application into the graphics manager event for the graphics manager application comprises converting the packetized human interface event data by the user-space application to appear to the graphics manager application as a different human interface device.

20. A first processor disposed in a user interface system comprising a human interface device, a second processor, and a data link, the first processor having a tangible, non-transient storage medium with instructions stored thereon, which, when executed, cause the first processor to perform steps comprising:
receiving human interface event data indicating a user's physical interaction with the human interface device and associated coordinates;
packetizing the human interface event data according to a protocol readable by a user-space application running on the second processor so as to be converted by the user-space application into a graphics manager event for a graphics manager application; and
communicating the packetized human interface event data over the data link to the second processor.
